(19) United States
(12) Patent Application Publication
(10) Pub. No.: US 2009/0246539 A1
(43) Pub. Date: Oct. 1, 2009

(54) Thermally-Hardening Silicone Coating Suitable as Adhesive

(75) Inventor: Wolf-Ruediger Huck, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 11/660,951

(22) PCT Filed: Sep. 2, 2005
(86) PCT No.: PCT/EP05/54319

§ 371 Date: Aug. 6, 2008

(30) Foreign Application Priority Data
Sep. 3, 2004 (EP) 04104256.5

(51) Int. Cl. B32B 27/08; B05D 3/02; B32B 37/00

(52) U.S. Cl. 428/447; 427/379; 156/60; 156/331.4

(57) ABSTRACT

The invention relates to thermally-hardening silicone coatings on a thermoplastic plastic, characterised in being able to be used as adhesive without an adhesive primer. Such thermally-hardening silicone coatings are produced by a method comprising the following steps: application of a silicone composition to the surface of a thermoplastic plastic, or the surface of a thermoplastic plastic treated with an adhesive primer, at least a partial drying off of the silicone composition to form a silicone film, application of a bonding composition to the silicone film and baking at a temperature of 80° C. to 200° C.

### TECHNICAL FIELD

The invention relates to the field of heat-cured silicone coatings on thermoplastics as well as processes for their preparation and bonding.

### PRIOR ART

Thermoplastics have been used for a long time. However, some disadvantages are associated with their use. They are very susceptible to scratches because of their softness. This is very disadvantageous in particular for visible and/or exposed plastic parts. Many of these thermoplastics are transparent and thus are often used as alternatives to glass for panels or covers. In these applications, scratches are also very disadvantageous, since light is deflected by scratches and thus they can be unclear to hazy.

In order to eliminate these disadvantages of thermoplastics, for a long time they have been coated with scratch-resistant silicone compositions. Such silicone compositions are applied to the thermoplastics and baked. These heat-cured silicone coatings are also known to the person skilled in the art by the English term “silicone hardcoats.” For example, such coatings are disclosed by U.S. Pat. No. 5,041,313, U.S. Pat. No. 4,624,870, and EP 0 570 165 A2, or G. Modford et al. in “The next generation in weatherable hardcoats for polycarbonate”, International Coatings for Plastics Symposium, 4-6 Jun. 2001, Troy, Mich. USA. However, often molded parts made from such thermoplastics treated with heat-cured silicone coatings must be joined to other molded parts.

Due to the known advantages of adhesive technology, it is desirable to bond these parts. However, it has been shown that such coated parts are very difficult to bond with conventional adhesives, especially with one-component polyurethane adhesives.

EP 1 382 625 A1 solves this problem by using a special isocyanate-containing primer with good adhesion to plastics such as poly(methylmethacrylate) or polycarbonate which have polydimethylsiloxane-based coatings (PDMS-PMMA or PDMS-PC). However, this has the disadvantage that an additional step is required in the production line employing such molded parts, namely application of the primer. But even more of a disadvantage is the fact that because of the required air-drying, i.e., the time between application of the primer and application of the adhesive, there is a waiting period which for continuous production, for example, involves intermediate storage. Furthermore, the solvents typically present in primers often lead to stress corrosion cracking.

### DESCRIPTION OF THE INVENTION

The aim of the present invention is therefore to provide a heat-cured silicone coating on a thermoplastic which is to be bonded with an adhesive but without a primer.

“To be bonded without a primer” here and in the following is understood to mean the property of bondability without the use of an adhesive primer.

It has now been surprisingly discovered that such a coating can be achieved by a process as specified in Claim 1.

### EMBODIMENTS OF THE INVENTION

The present invention relates to a process for preparation of a heat-cured silicone coating on a thermoplastic. This process includes the steps:
Application of a silicone composition to the surface of a thermoplastic or to the surface of a thermoplastic treated with a plastic primer
at least one partial air-drying of the silicone composition to form a silicone film
application of an adhesion promoter composition to the silicone film
baking at a temperature between 80° C. and 200° C.

The silicone composition typically includes a dispersion of a colloidal silicic acid in a mixture of water and an organic solvent and at least one trialkoxysilane RSi(OR′)₃ or its silanol RSi(OR′)₃₋ₙ(OH)ₙ or partial condensates thereof. Here R represents an alkyl substituent with 1-3 carbon atoms or an aryl substituent with 6 to 13 carbon atoms, R′ represents an alkyl substituent with 1-3 carbon atoms, and n represents 1, 2, or 3. R is preferably a methyl group. R′ is also preferably a methyl group. Detailed processes for preparation of silicone compositions as well as heat-cured silicone coatings prepared from them are described, for example, in the patents U.S. Pat. No. 4,373,061, U.S. Pat. No. 4,624,870, U.S. Pat. No. 5,869,185, and U.S. Pat. No. 5,041,313 and are therefore considered as incorporated by reference in the present invention. The solids fraction in the silicone composition is typically from 10 to 30 wt. %, in particular from 15 to 25 wt. %. Furthermore, the pH of the silicone composition is preferably between 6 and 8.5, in particular between 6.5 and 8. A preferred component of the silicone composition is an alkoxysilated UV absorber, in particular one such as are mentioned in this section of the indicated patents. Suitable silicone compositions are commercially available as coating agents for preparation of heat-cured silicone coatings (hardcoats), for example from PPG Industries Ohio as Resilient or from GE Silicones as PHC587, AS4000, or AS4700, or from SDC Technologies, Inc. as CrystalCoat® or Supercoat, as well as similar systems such as those marketed by Fujikura Kasei.

In principle, the thermoplastic on which the silicone composition is applied can be any known thermoplastic. Especially suitable thermoplastics are those which do not change or do not substantially change their shape during baking. Therefore the thermoplastics should have a glass transition temperature preferably above 100° C., in particular above 120° C.

The thermoplastic is preferably transparent.

Especially preferred thermoplastics are firstly homopolymers or copolymers of monomers selected from the group including methacrylic acid, acrylic acid, methacrylic acid ester, acrylic acid ester, styrene, as well as any mixtures thereof. Among these homopolymers or copolymers, poly(methylmethacrylate) is preferred.

Alternatively, polycarbonates, in particular bisphenol A-based polycarbonates, as well as amorphous polyesters such as PETG or PET are preferred.

Aromatic thermoplastics are preferred, in particular aromatic polycarbonates such as those [available] under the name Lexan® polycarbonates from General Electric or under the name Makrolon® from Bayer.

Depending on the application, other thermoplastics or blends thereof can also be used, such as, for example, polyphenylene ethers, polyetherimides, polyesters, polyamides, or polysulfones.

The adhesion promoter composition preferably includes at least one organosilicon compound and/or at least one organotitanium compound. Here the organosilicon compound has at least one alkoxy group bonded to a silicon atom as well as at least one organic substituent bonded to a silicon atom through a carbon-silicon bond. Here the organotitanium compound has at least one substituent bonded to the titanium atom through an oxygen-titanium bond.

Organosilicon compounds of formula (I) or (II) or (III) are especially suitable as the organosilicon compounds:

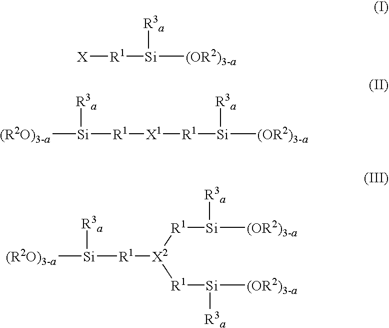

R¹ stands here for a linear or branched, optionally cyclic alkylene group with 1 to 20 C atoms, optionally with aromatic moieties and optionally with one or more heteroatoms, in particular nitrogen atoms.

R² stands here for an alkyl group with 1 to 5 C atoms, in particular a methyl or ethyl group.

R³ stands here for an alkyl group with 1 to 8 C atoms, in particular a methyl group.

X stands here for an H or a functional group selected from the group including oxirane, OH, (meth)acryloxy, amine, SH, acylthio and vinyl, preferably amine. For the sake of completeness, we mention that in this document, by acylthio we mean the substituent

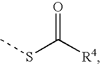

where R⁴ stands for alkyl, in particular with 1 to 20 carbon atoms, and the dashed line represents the bond with the substituent R¹.

X¹ stands here for a functional group selected from the group including NH, S, S₂, and S₄.

X² stands here for a functional group selected from the group including N and isocyanurate.

a stands here for one of the values 0, 1, or 2, preferably 0.

The substituent R¹ means in particular a methylene, propylene, methylpropylene, butylene, or dimethylbutylene group. The substituent R¹ is particularly preferably a propylene group.

Organosilicon compounds having amino, mercapto, or oxirane groups are also called “aminosilanes,” “mercaptosilanes,” or “epoxysilanes.”

Suitable organosilicon compounds of formula (I) include, for example, organosilicon compounds selected from the group including methyltrimethoxysilane, octyltrimethoxysilane, dodecyltrimethoxysilane, hexadecyltrimethoxysilane, methyloctyldimethoxysilane; 3-glycidyloxypropyltrimethoxysilane, 3-glycidyloxypropyltriethoxysilane; 3-methacryloxypropyltrialkoxysilanes, 3-methacryloxypropyltriethoxysilane, 3-methacryloxypropyltrimethoxysilane; 3-aminopropyltrimethoxysilane, 3-aminopropyltriethoxysilane, 3-aminopropyldimethoxymethylsilane, 3-amino-2-methylpropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane; 3-mercaptopropyltriethoxysilane, 3-mercaptopropyltrimethoxysilane, 3-mercaptopropylmethyldimethoxysilane; 3-acylthiopropyltrimethoxysilane; vinyltrimethoxysilane and vinyltriethoxysilane.

Suitable organosilicon compounds of formula (II) include, for example, organosilicon compounds selected from the group including bis[3-(trimethoxysilyl)propyl]amine, bis[3-(triethoxysilyl)propyl]amine, 4,4,15,15-tetraethoxy-3,16-dioxa-8,9,10,11-tetrathia-4,15-disilaoctadecane (bis(triethoxysilylpropyl)polysulfide or bis(triethoxysilylpropyl)tetrasulfane), bis(triethoxysilylpropyl)disulfide.

Suitable organosilicon compounds of formula (III) include, for example, organosilicon compounds selected from the group including tris[3-(trimethoxysilyl)propyl]amine, tris-[3-(triethoxysilyl)propyl]amine, 1,3,5-tris[3-(trimethoxysilyl)propyl]-1,3,5-triazine-2,4,6(1H,3H,5H)-trione urea (=tris(3-(trimethoxysilyl)propyl)isocyanurate), and 1,3,5-tris(3-(triethoxysilyl)propyl]-1,3,5-triazine-2,4,6(1H,3H,5H)-trione urea (=tris(3-(triethoxysilyl)propyl)isocyanurate).

Aminosilanes are preferred as the organosilicon compounds, in particular aminosilanes with X═NH₂ or NH₂—CH₂—CH₂—NH, X¹═NH and X²═N. Especially preferred are: 3-aminopropyltrimethoxysilane, N-(2-aminoethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane, and bis[3-(triethoxysilyl)propyl]amine as well as mixtures thereof. It has been shown that in particular with aminosilanes, especially for aminosilanes mentioned in this section, microcracking of the heat-cured silicone coating is reduced.

As the substituents bound to the titanium atom through an oxygen-titanium bond, especially suitable substituents are selected from the group including an alkoxy group, sulfonate group, carboxylate group, dialkyl phosphate group, dialkyl pyrophosphate group, and acetylacetonate group.

Compounds are especially suitable in which all the substituents bonded to the titanium are selected from the group including an alkoxy group, sulfonate group, carboxylate group, dialkyl phosphate group, dialkyl pyrophosphate group, and acetylacetonate group, where all the substituents can be the same of different from each other.

As the alkoxy groups, in particular “neoalkoxy” substituents have proven to be especially suitable, in particular those of formula (IV) below:

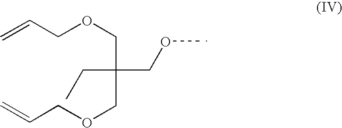

As the sulfonic acids, in particular aromatic sulfonic acids have proven to be especially suitable in which the aromatics are substituted with an alkyl group. Groups of formula (V) below are considered as preferred sulfonic acids:

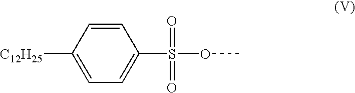

As the carboxylate groups, fatty acid carboxylates in particular have proven to be especially suitable. Decanoate is considered as a preferred carboxylate.

Here in all the above formulas, the dashed bond indicates the oxygen-titanium bond.

Organotitanium compounds are commercially available, for example from Kenrich Petrochemicals or DuPont. Examples of suitable organotitanium compounds are, for example, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals or Tyzor® ET, TPT, NPT, BTM, M, M-75, AA-95, AA-105, TE, ETAM from DuPont. Ken-React® KR 7, KR 9S, KR 12, KR 26S, KR 38S, KR44, LICA 09, LICA 44, NZ 44, as well as Tyzor® ET, TPT, NPT, BTM, M, AA-75, AA-95, AA-105, TE, ETAM from DuPont are considered as preferred.

Especially preferred are organotitanium compounds with substituents of formula (IV) and/or (V) bonded to the titanium atom through an oxygen-titanium bond.

The adhesion promoter composition preferably includes at least one organosilicon compound and at least one organotitanium compound.

The adhesion promoter composition can additionally include at least one solvent. Especially preferred solvents are those that do not lead to stress cracking either for the thermoplastic or for the plastic primer present if necessary. Particularly suitable solvents are readily volatile solvents, i.e., solvents with a boiling point at 760 torr between 40° C. and 140° C., in particular between 50° C. and 120° C., preferably between 65° C. and 99° C. It has additionally been shown that mixtures of different solvents in particular are advantageous. It has been shown that it is especially suitable to use mixtures of at least one hydrocarbon and at least one polar solvent which has at least one heteroatom in its structural formula. The hydrocarbon can be saturated, or olefinic or aromatic unsaturated. The hydrocarbon is preferably saturated. O, N, and S in particular are considered as suitable as a heteroatom in the polar solvent. It is preferred for at least one heteroatom in the structural formula of the polar solvent to be an oxygen atom, which is especially preferred in the form of hydroxyl, carbonyl, ether, carboxylic acid, or carboxylic derivative groups such as, for example, an ester, amide, or carboxylate group. Water, alcohols, and ketones are preferred polar solvents. The most preferred polar solvents are alcohols, in particular saturated, branched or linear or cyclic alcohols with 1 to 8 carbon atoms.

Preferred solvents are alcohols and aliphatic and cycloaliphatic hydrocarbons, in particular ethanol, isopropanol, hexane, cyclohexane, heptane, or octane. The solvent ethanol or heptane is preferred.

Solvent mixtures of an alcohol and an aliphatic or cycloaliphatic hydrocarbon are considered as especially preferred, in particular such mixtures of ethanol or isopropanol with hexane or cyclohexane or heptane or octane. The mixture of ethanol and heptane has been shown to be an especially preferred solvent mixture.

When such a solvent is used, then uniformly low concentrations of adhesion promoter substances, i.e., of the organosilicon compound and/or the organotitanium compound, can be applied to the silicone film. The solvent content is selected so that the content of the organosilicon compound and/or organotitanium compound is from 1 to 20 wt. %, in particular between 2 to 10 wt. %.

However, it can certainly also be advantageous for the adhesion promoter composition to contain no solvent and for the content of organosilicon compound and/or organotitanium compound to be more than 90 wt. %, in particular more than 99 wt. %. For example, in this way the VOC regulatory limits or disadvantages can be avoided or, if necessary, solvent-related changes in properties of the silicone film can be eliminated.

The adhesion promoter composition can include additional components. UV absorbers and optical brighteners are especially suitable as additional components. Optical brighteners can be used, for example, for quality control; i.e., using them as tracers with inspection under UV light, it can be determined whether or not the adhesion promoter composition was applied during preparation of the heat-cured silicone coating. Such optical brighteners absorb UV light and emit visible (typically blue) light. A preferred optical brightener is Ciba Uvitex® OB from Ciba Specialty Chemicals.

Additional suitable optical brighteners are given, for example, in Kirk-Othmer, Encyclopedia of Chemical Technology, 4th Ed., John Wiley & Sons, New York, Vol. 11, pp. 227-241.

Since the thermoplastic material as well as the heat-cured coating thereon are often transparent, UV absorbers can be used to protect an adhesive bonded to the heat-cured silicone coating against UV radiation passing through the thermoplastic material as well as the heat-cured silicone coating thereon. Such UV protection is especially very advantageous for polyurethane adhesives. For example, the UV absorbers can be organic, such as for example from the Tinuvin® product line of Ciba Specialty Chemicals, or they can be inorganic such as for example colored pigments, in particular carbon black or titanium dioxide.

Preferably the adhesion promoter composition is free of compounds containing isocyanate groups. It has been specifically determined that the presence of such isocyanate group-containing compounds in the adhesion promoter composition leads to mechanical weak spots in the heat-cured silicone coating prepared with it. It is suspected that before baking or during baking, the reactive isocyanate groups react with the silicone composition and therefore interfere with crosslinking of the silicone composition.

The silicone composition can be applied by quite diverse application methods such as spraying, dipping, roller coating, etc. known to the person skilled in the art. The dry film layer thickness for the silicone composition is preferably between 5 and 15 micrometers. Several layers can be applied consecutively.

In addition it may be necessary to apply a plastic primer to the thermoplastic before application of the silicone coating, in order to ensure good adhesion of the silicone composition to the thermoplastic. The layer thickness for such a plastic primer is typically 0.1 to 3 micrometers. By “plastic primer”, here and in this entire document we mean a primer that is applied to a thermoplastic before application of a silicone composition.

In addition, it may be advantageous to apply an interlayer with UV-screening substances or colorants. Such interlayers may also be desirable from a purely aesthetic or decorative viewpoint.

If interlayers are used, they can also be present only at certain spots on the thermoplastic surface or on the layers adherent thereon, and do not have to be present over the entire surface area. As an example, we mention a polycarbonate panel of an automobile with a covering interlayer at the edge of the panel, where the adhesive bonds the panel to the flange of the body or to the aluminum or electrocoated steel frame.

The silicone composition must be at least partially air-dried. That is, a certain amount of time must elapse before further operations can be carried out. The silicone composition forms a film during this period. Typically at least one partial drying is carried out by evaporation of a solvent and/or preliminary reaction of the reactive components of the silicone composition. The length of this partial air-drying time and the extent of the air drying is quite variable and very dependent on the details of the formulation of the silicone composition. However, it is as least long enough so that the silicone composition forms a film, hereinafter called the silicone film. This time can be shortened as needed within certain limits by blowing air, especially warm air, over the thermoplastic polymer or by gently heating it (but definitely below the baking temperature). But the air-drying time typically is at least 5 minutes. The partial air-drying time is preferably between 5 minutes and 60 minutes, in particular between 5 and 30 minutes, preferably between 5 and 25 minutes.

After partial air-drying, the adhesion promoter composition is applied to the silicone film formed. However, the application can be carried out before the silicone composition is completely air-dried. In principle, the composition can be applied in quite diverse ways. Spraying it on is the preferred application method. As needed, a mask can be used for this purpose in order to selectively apply a pattern or to selectively treat one section. The amount of the adhesion promoter composition applied varies quite considerably depending on the solvent optionally present. The adhesion promoter composition is preferably applied to the silicone film in an amount between 10 and 200 g/m², in particular between 30 and 100 g/m². Preferentially 0.02 to 40 g/m², in particular 0.1 to 20 g/m², preferably 0.5 to 10 g/m² of the organosilicon compound and/or organotitanium compound is applied to the silicone film.

The adhesion promoter composition can be applied in two or more consecutive steps. This can be done either by consecutive wet-on-wet application or by application only after air-drying of the already applied adhesion promoter composition. Preferably 10 seconds to 1 minute elapses between two consecutive applications of the adhesion promoter composition. A higher concentration of adhesion promoter substance, i.e., of organosilicon compound and/or organotitanium compound, can be easily applied uniformly by repeated applications of the adhesion promoter composition.

An air-drying step preferably is carried out after application of the adhesion promoter composition. This step in particular allows any possible solvents to evaporate before the baking process. This is advantageous from an occupational safety viewpoint, or desirable in order to ensure better surface quality for the coating. Without the evaporation step, these would possibly be jeopardized by solvent escaping during baking of the coating. But such air-drying is not usually necessary for solvent-free adhesion promoter compositions.

The air-drying time for the adhesion promoter composition is quite dependent on the solvent used, and is usually between 10 seconds and 1 day, in particular between 10 seconds and 5 minutes, preferably between 30 seconds and 3 minutes.

The production process is usually not slowed down because of the air-drying, since the transport time between the area where the adhesion promoter composition is applied and the baking area is typically much shorter [sic] than the air-drying time for the adhesion promoter composition.

Furthermore, usually the production process is not slowed down by additional application of the adhesion promoter composition and if necessary its air-drying, since the adhesion promoter composition is typically applied before complete air-drying of the silicone composition.

After application of the adhesion promoter composition and optionally after its air-drying, the coating is baked at a temperature between 80° C. and 200° C. The baking temperature and the baking time are preferably adjusted according to the silicone composition and the thermoplastic.

Usually baking is carried out at a temperature between 100° C. and 140° C., in particular between 120° C. and 130° C., typically for a baking time between 30 minutes and 90 minutes, in particular between 40 minutes and 60 minutes. It can be advantageous for the baking temperature to not stay constant during the baking process but rather to vary according to a temperature profile. Baking is usually carried out in ovens. Further details concerning baking of silicone compositions for preparation of heat-cured silicone coatings on a thermoplastic are known to the person skilled in the art from the already indicated prior art in the description of the silicone compositions.

The silicone coating is cured during the baking process, i.e., the silicone coating is cured and forms a network. Although currently no experimental evidence is available, it is assumed that the concentration of the composition originating from the adhesion promoter composition in the near-surface area of a heat-cured silicone coating as described above is higher than the concentration close to the silicone coating/thermoplastic interface.

The heat-cured silicone coatings have excellent long-term stability and in particular tends to exhibit no or just a little stress cracking, and hence long life of the coating can be ensured.

A heat-cured silicone coating prepared in this way is surprisingly quite well suited to primer-free bonding to various adhesives.

Adhesion does not occur without the use of an adhesive primer if the silicone coatings are prepared without the step of applying the adhesion promoter composition to the silicone film. By “adhesive primer”, here and in this entire document we mean a primer that is applied to a heat-cured silicone coating to which an adhesive is or can be applied.

Adhesion also does not occur without the use of an adhesive primer if the adhesion promoter composition is applied wet-on-wet directly after application of the silicone composition, i.e., if the heat-cured silicone coating is prepared without the step of at least partial air-drying of the silicone coating to form a silicone film.

Adhesion usually also does not occur without the use of an adhesive primer if the adhesion promoter composition is applied after baking and not before baking.

Preferred adhesives are those based on epoxy resin, monomers or oligomers containing (meth)acrylate groups, alkoxysilane-terminated prepolymers, or isocyanate-terminated prepolymers.

Considered as suitable adhesives based on epoxy resins are firstly two-component adhesives in which one component includes an amine or mercaptan curing agent and the second component includes a diglycidyl ether of bisphenol A or bisphenol F or bisphenol A/F. Examples of such 2-component epoxy resin adhesives are those from the Sikadur® product line, such as are commercially available from Sika Schweiz AG [Sika Switzerland].

One-component heat-curing epoxy resin adhesives are also considered as suitable epoxy resin-based adhesives. Such adhesives usually contain a curing agent which is free or active only at higher temperature. Dicyandiamide (dicy) is an example of such a curing agent. Particularly preferred 1-component heat-curing epoxy resin adhesives are those with high impact strength such as are disclosed, for example, in EP 1 359 202 A1. Examples of 1-component heat-curing epoxy resin adhesives are those from the SikaPower® product line, such as are commercially available from Sika Schweiz AG.

Considered as suitable adhesives based on monomers or oligomers containing (meth)acrylate groups in particular are two-component room temperature-curing (meth)acrylate adhesives which in a first component contain a radical initiator, in particular organic peroxides, preferably benzoyl peroxide, and in a second component contain monomers or oligomers having (meth)acrylate groups. Examples of such two-component room temperature-curing (meth)acrylate adhesives are those from the SikaFast® product line, such as are commercially available from Sika Schweiz AG.

Suitable adhesives based on alkoxysilane-terminated prepolymers are one-component moisture-curing adhesives that are prepared [from?] an “MS polymer” or alkoxysilane-terminated polyurethane prepolymer, in particular those such as are synthesized from polyols and isocyanates with subsequent reaction of an isocyanate-reactive organosilane or an isocyanate-functional organosilane.

Considered as suitable adhesives based on isocyanate-terminated prepolymers are first of all two-component polyurethane adhesives where the first component includes an amine or polyol and the second component includes an NCO-containing prepolymer. Examples of such two-component room temperature-curing polyurethane adhesives are those from the SikaForce® product line, such as are commercially available from Sika Schweiz AG.

Also considered as suitable adhesives based on isocyanate-terminated prepolymers are reactive polyurethane hot melt adhesives containing a thermoplastic polymer as well as an isocyanate-terminated prepolymer or a thermoplastic isocyanate-terminated prepolymer. Such reactive polyurethane hot melt adhesives are melted and on the one hand are set during cooling, and on the other hand are crosslinked via a reaction with moisture in the air.

Also considered as suitable adhesives based on isocyanate-terminated prepolymers are one-component moisture-curing polyurethane adhesives. Such adhesives are crosslinked under the influence of moisture, in particular moisture in the air. Examples of such one-component moisture-curing polyurethane adhesives are those from the SikaFlex® and SikaTack® product lines, such as are commercially available from Sika Schweiz AG.

The above-mentioned isocyanate-terminated prepolymers are synthesized from polyols, in particular polyoxyalkylene polyols, and polyisocyanates, in particular diisocyanates.

Adhesives based on isocyanate-terminated prepolymers are preferred.

For bonding, the adhesive is brought into contact with the heat-cured silicone coating without pretreatment of the latter using an adhesive primer. Furthermore, in bonding the heat-cured silicone coating is bonded to another joining part using an adhesive.

Bonding can be carried out in such a way that the adhesive is applied to the heat-cured silicone coating and then is bonded to another joining part, or the adhesive is first applied to another joining part and then bonded to the heat-cured silicone coating. The adhesive can also be pressed into a gap formed by the heat-cured silicone coating and the other joining part. In another application method, which is not preferred, the adhesive is applied to both the heat-cured silicone coating and the other joining part and then these are bonded to each other.

After the joining parts are joined, the adhesive is cured and thus durably bonds the joining parts. A composite formed in this way has durable adhesion for quite different climatic conditions and can carry high mechanical loads.

The heat-cured silicone coating is not pretreated with an adhesive primer, but it can certainly be advantageous to clean it before bonding. Such cleaning includes in particular wiping, preferably with a readily volatile solvent. The solvent should preferably be inert relative to the coating. Here it also must be made sure that the solvent is removed as completely as possible before the adhesive is applied to the cleaned surface or comes into contact with it.

The other joining part can be made from various materials. Firstly plastics, then metals, and finally glass and glass ceramics are preferred. The plastics are the conventional plastics considered relevant in adhesive technology. In a particularly preferred case, the other joining part is also a heat-cured silicone coating, or a thermoplastic coated with a heat-cured silicone coating. Thus the other joining part can also be identical to the heat-cured silicone coating according to the invention, or to the thermoplastic coated with it.

Especially preferred metals are iron, aluminum, copper, and chromium metals and alloys. Steels and aluminum as well as alloys thereof are especially preferred. It is especially preferred that the metals be lacquered. Automobile lacquer is particularly preferred as the lacquer.

Glass and glass ceramics are also preferred substrates. In particular glass which is called float glass as well as articles fabricated from it, in particular panels, are preferred. In particular, glass ceramics are preferred which are silk-screened and then baked.

The other joining part can be pretreated or not before bonding with a primer or an adhesion promoter composition. This depends considerably on the material from which the joining parts are made or the climatic conditions where such a composite will be used.

In another embodiment, the heat-cured silicone coatings are sheathed by a reactive or more precisely thermoplastic material. These are in particular panels which are sheathed with a reactive material such as, for example, a one-component or two-component polyurethane, by means of a RIM (Reaction Injection Molding) process or by application of a thermoplastic such as, for example, thermoplastic polyurethane (TPU).

A composite formed in this way is preferably a vehicle, in particular an automobile or a portion thereof. In automobile assembly, often bonded modules are used or components are bonded on the production line.

Especially preferred is bonding of panels made from transparent plastic, in particular from polycarbonate, coated with a coating according to the invention, to the body of a vehicle, in particular an automobile, wherein the bonding is usually done to a flange or frame. The body, or the flange or frame, is typically made from lacquered metal.

Especially preferred embodiments are sunroofs and side windows.

Another preferred embodiment of the invention is a headlight lens made from polycarbonate coated with a heat-cured silicone coating according to the invention, or a headlight made by bonding such a headlight lens to a headlight housing.

Other options for embodiments according to the invention arise from the areas of application for thermoplastics that are coated with a heat-cured silicone coating according to the invention, and especially for those where such materials are bonded or are to be bonded.

Thus thermoplastics that are coated with a heat-cured silicone coating according to the invention find application in manufacture, for example, of lamp housings, safety eyeglasses, light bulb covers, display covers, safety glass and safety panels, roofs, media such as CDs or DVDs or the like etc., in particular where an adhesive is used in manufacture of these articles, or where these articles are bonded to other joining parts.

A new application of thermoplastics, namely for OLED films (organic light emitting diodes), is also a subject matter of the invention. Here organic molecules that are incorporated into the thermoplastic can be stimulated to selectively emit light by passage of current and thus can be used to display information. The mode of operation and manufacture of such OLEDs is known, for example from Matthias Rehen, “Elektrisch leifähige Kunststoffe [Electrically conductive plastics]”, Chemie in Unserer Zeit (2003), pp. 17-30, or from U.S. Pat. No. 6,703,184 or U.S. Pat. No. 5,247,190. Such OLEDs can be used as films for OLED displays. OLED displays are already marketed by Cambridge Technology and Kodak. To protect these OLED films, now the thermoplastic can be coated with a heat-cured silicone coating by the process according to the invention.

Such films are suitable in particular as thin display units for computers and can also be used as information carriers for advertising purposes. Important properties of these films is their small thickness and their resulting flexibility, which allows display of information such as cannot be achieved with conventional information technology. Thus such a film can be rolled or can completely conform to the contours of a body so that complex geometries can be achieved.

All these applications share in common the fact that bonding polycarbonate films coated with a heat-cured silicone coating is especially desirable. Thus a heat-cured silicone coating according to the invention that is possible without treatment using an adhesive primer represents a technological and economic advantage.

### EXAMPLES

### Preparation of Adhesion Promoter Compositions

TABLE 1
Substances used.

| | Name | Chemical name |
|---|---|---|
| A1120 | Silquest A-1120 Silane | N-(2-aminoethyl)-3- |
| | (GE Silicones) | aminopropyltrimethoxysilane |
| A1170 | Silquest A-1170 Silane | bis[3-(trimethoxysilyl)propyl]amine |
| | (GE Silicones) | |
| (BuO)₄Ti | Titanium(IV) butoxide | tetra(n-butyl)titanate |
| | (Fluka AG) | |
| Heptane | Heptane, puriss purity | Heptane |
| | grade (Fluka AG) | |
| EtOH | Ethanol, absolute | Ethanol |
| | (Fluka AG) | |
| SA | Sika ® Aktivator | aminoalkylalkoxysilane/titanate in |
| | (Sika Schweiz AG) | hydrocarbon/ethanol mixture |

The adhesion promoter substances HV1 to HV8 were [prepared] according to Table 2, where the organosilicon compound and/or titanium compound was added with stirring under an inert atmosphere to the respective solvent and then stirring was continued for 1 hour.

Then glass bottles were filled with the adhesion promoter compositions and tightly sealed.

TABLE 2
Adhesion promoter compositions (figures in wt. %).

| | Ref. 1 | Ref 2 | HV1 | HV2 | HV3 | HV4 | HV5 | HV6 | HV7 | HV8 |
|---|---|---|---|---|---|---|---|---|---|---|
| A1120 | | | | | 20 | 20 | | | 10 | |
| A1170 | | | 10 | 20 | | | 20 | | | 10 |
| (BuO)₄Ti | | | | | | | | 20 | 10 | 10 |
| Heptane | | 100 | | | | 80 | 80 | 80 | 80 | 80 |
| EtOH | 100 | | 90 | 80 | 80 | | | | | |

### Preparation of Heat-Cured Silicone Coatings

All the coating experiments were carried out at 23° C. and 50% relative air humidity. Makrolon® AL2647 polycarbonate plates from Bayer were used as the substrate. Before use, the plates of dimensions 10 cm×15 cm×3 mm were cleaned by wiping with an isopropanol-soaked lint-free cloth and then air-dried for 3 minutes. PHC 587 and AS4700, both commercially available from GE Silicones, were used as the silicone compositions. When AS4700 was used, the polycarbonate plates were first flow-coated with the recommended plastic primer SHP470 Basecoat from GE Silicones, i.e., the plastic primer was uniformly sprayed on the vertically positioned plate using a spray bottle and allowed to air-dry in this position for 20 minutes. Then the coated plate was heat-treated for 25 minutes at 125° C. in a convection oven.

Using a spray bottle, PHC 587 was sprayed uniformly on the vertically positioned cleaned polycarbonate plates, or AS4700 was sprayed uniformly on the vertically positioned primered polycarbonate plates, while they were allowed to dry in a vertical position for the partial air-drying time given in Tables 3 to 7 as “Tₓ”, and then the respective adhesion promoter compositions HV1 to HV8, or Sika® Aktivator (SA), were sprayed on the vertically positioned plates in an amount of 50 g/m². For certain experiments (B11, B14, B17, B20, and B25), this spraying was done one more time immediately after that, resulting in a double amount applied. Then after waiting for the time given in Tables 3 to 7 as “T_{y}”, the coated test pieces, which had been kept in a vertical position, were placed in convection ovens preheated to 125° C. or 130° C., and they were baked in a horizontal position for 45 minutes at 125° C. for the AS4700-based silicone coatings or for 50 minutes at 130° C. for the PHC 587-based silicone coatings. The adhesives were applied to the heat-cured silicone coatings prepared in this way after cooling down for 3 hours, and the adhesion was determined as described below. Round beads of the one-component, moisture-curing polyurethane adhesives Sikaflex®221 (“SF221”), SikaTack®-Plus (“STP”), and SikaTack®-Ultrafast (“STUF”) (all commercially available from Sika Schweiz AG) were applied to the heat-cured silicone coatings using an extrusion cartridge and nozzles.

The adhesive was tested after a cure time of 7 days storage in an environmental chamber (EC) (23° C., 50% relative air humidity), and after subsequent water storage (WS) in water at 23° C. for 7 days, and after subsequent poultice storage (PS) for 7 days at 70° C., 100% relative air humidity.

The adhesion of the adhesive was tested using the “bead test”. For this, the bead is cut at the end just above the adhesive surface. The cut end of the bead is held with round-tip forceps and pulled from the substrate. This is done by carefully rolling up the bead on the tip of the forceps, and placing a cut perpendicular to the direction in which the bead is pulled, down to the bare substrate. The bead peel rate should be selected so that a cut must be made approximately every 3 seconds. The test distance must be at least 8 cm. The adhesive remaining on the substrate after peeling off the bead is assessed (cohesive failure).

The adhesive properties are assessed by estimating the area fraction of cohesive failure:

1≧95% cohesive failure

2=75%-95% cohesive failure

3=25%-75% cohesive failure

4≦25% cohesive failure

5=0% cohesive failure (purely adhesive failure)

The additional letter “B” indicates that the heat-cured silicone coating detached from the polycarbonate and so the silicone coating exhibits a weak spot. Test results with cohesive failures below 75% are typically regarded as unsatisfactory.

TABLE 3
Adhesion of adhesive to polycarbonate coated with heat-cured
silicone coatings (PHC587 as the silicone composition).

| PHC587 | Adhesion | Tₓ | | T_{y} | SF221 | | | STP | | | STUF | | |
|---|---|---|---|---|---|---|---|---|---|---|---|---|---|
| Coating | promoter | [min] | #* | [min] | EC | WS | PS | EC | WS | PS | EC | WS | PS |
| R1 | — | — | — | — | 5 | 5 | 5 | 5 | 5 | 5 | 5 | 5 | 5 |
| R2 | Ref. 1 | 10 | 1 | 10 | 5 | 5 | 5 | 5 | 5 | 5 | 5 | 5 | 5 |
| R3 | Ref. 2 | 10 | 1 | 10 | 5 | 5 | 5 | 5 | 5 | 5 | 5 | 5 | 5 |
| B1 | HV1 | 10 | 1 | 10 | 4 | 5 | 4B | 5 | 5 | 5 | 5 | 5 | 5 |
| B2 | HV2 | 10 | 1 | 10 | 2 | 3 | 3 | 3 | 2 | 5B | 2/3 | 3 | 5B |
| B3 | HV3 | 10 | 1 | 10 | 4 | 4 | 5B | 3 | 3 | 5B | 3 | 4 | 5B |
| B4 | HV4 | 10 | 1 | 10 | 2 | 1 | 3 | 2 | 4 | 5B | 1 | 1 | 5B |
| B5 | HV5 | 10 | 1 | 10 | 1 | 1 | 5B | 4 | 4 | 5B | 1 | 1 | 5B |
| B6 | HV6 | 10 | 1 | 10 | 3 | 3 | 3B | 5 | 5 | 4B | 5 | 5 | 4B |
| B7 | HV7 | 10 | 1 | 10 | 2 | 2 | 5B | 2 | 1 | 5B | 1 | 2 | 5B |
| B8 | HV8 | 10 | 1 | 10 | 4 | 4 | 5B | 4 | 3 | 5B | 3 | 2 | 5B |
| B9 | SA | 10 | 1 | 10 | 1 | 2 | 3 | 3 | 2 | 5B | 3 | 2 | 5B |

*= Number of applications of the adhesion promoter composition.

The adhesion results from Table 3 show that adhesion was considerably improved by application of the adhesion promoter composition, in particular after environmental chamber and water storage, while no adhesion was achieved for the reference silicone coatings R1, R2, and R3. In some cases, marked improvement could also be established for the adhesion after poultice storage, depending on the adhesive and the adhesion promoter composition.

The adhesion results from Table 4 as well as comparison of B1 with B2 show that, compared to the reference Examples, the adhesion is considerably improved if a critical amount of the adhesion promoter substance applied to the silicone film is exceeded. On the other hand, the results also show that too short a partial air-drying time (Tₓ=1 min) results in no improvement or only slight improvement in the adhesion. The adhesion was considerably improved by application of the adhesion promoter composition, in particular after environmental chamber and water storage, while no adhesion was achieved for the reference silicone coatings R1, R2, and R3. In some cases, marked improvement could also be established for the adhesion after poultice storage, depending on the adhesive and the adhesion promoter composition. In addition, it was shown that adhesion promoter compositions containing an organosilicon compound/organotitanium compound mixture (HV8, SA) especially resulted in considerable improvement in the adhesion after poultice storage, in particular for Sikaflex®-221.

TABLE 4
Adhesion of adhesive to polycarbonate coated with heat-cured
silicone coatings (PHC587 as the silicone composition). Influence
of amount and partial air-drying time.

| PHC587 | Adhesion | Tₓ | | T_{y} | SF221 | | | STP | | | STUF | | |
|---|---|---|---|---|---|---|---|---|---|---|---|---|---|
| Coating | promoter | [min] | #* | [min] | EC | WS | PS | EC | WS | PS | EC | WS | PS |
| R2 | Ref. 1 | 10 | 1 | 10 | 5 | 5 | 5 | 5 | 5 | 5 | 5 | 5 | 5 |
| R3 | Ref. 2 | 10 | 1 | 10 | 5 | 5 | 5 | 5 | 5 | 5 | 5 | 5 | 5 |
| B10 | HV2 | 1 | 1 | 19 | 5 | 5 | 3 | 4 | 4 | 5 | 4 | 4 | 4 |
| B2 | HV2 | 10 | 1 | 10 | 2 | 3 | 3 | 3 | 2 | 5B | 2/3 | 3 | 5B |
| B11 | HV2 | 10 | 2 | 10 | 2 | 2 | 3 | 2 | 2 | 5B | 1 | 2 | 4B |
| B12 | HV2 | 20 | 1 | 0 | 2 | 2 | 4B | 4 | 2 | 5B | 3 | 2 | 5B |
| B13 | HV3 | 1 | 1 | 19 | 5 | 5 | 5B | 5 | 5 | 5B | 5 | 5 | 5B |
| B3 | HV3 | 10 | 1 | 10 | 4 | 4 | 5B | 3 | 3 | 5B | 3 | 4 | 5B |
| B14 | HV3 | 10 | 2 | 10 | 2 | 3 | 5B | 3 | 2/3 | 5B | 2 | 3 | 5B |
| B15 | HV3 | 20 | 1 | 0 | 4 | 5 | 5B | 4 | 4 | 5B | 4 | 4 | 5B |
| B16 | HV8 | 1 | 1 | 19 | 5 | 5 | 3B | 5 | 5 | 5 | 5 | 5 | 5 |
| B8 | HV8 | 10 | 1 | 10 | 4 | 4 | 5B | 4 | 3 | 5B | 3 | 2 | 5B |
| B17 | HV8 | 10 | 2 | 10 | 2 | 4 | 5B | 3 | 3 | 5B | 2 | 3 | 5B |
| B18 | HV8 | 20 | 1 | 0 | 1 | 1 | 5B | 4 | 4 | 5B | 3 | 2 | 5B |
| B19 | SA | 1 | 1 | 19 | 5 | 5 | 4B | 5 | 5 | 5B | 5 | 5 | 5B |
| B9 | SA | 10 | 1 | 10 | 1 | 2 | 3 | 3 | 2 | 5B | 3 | 2 | 5B |
| B20 | SA | 10 | 2 | 10 | 1 | 1 | 3 | 2 | 1 | 5B | 1 | 2 | 5B |
| B21 | SA | 20 | 1 | 0 | 2 | 2 | 5B | 1 | 2 | 5B | 2 | 1 | 5B |

*= Number of applications of the adhesion promoter composition.

TABLE 5
Adhesion of adhesive to polycarbonate coated with heat-cured
silicone coatings (AS4700 as the silicone composition).

| AS4700 | Adhesion | Tₓ | | T_{y} | SF221 | | | STP | | | STUF | | |
|---|---|---|---|---|---|---|---|---|---|---|---|---|---|
| Coating | promoter | [min] | #* | [min] | EC | WS | PS | EC | WS | PS | EC | WS | PS |
| R4 | — | — | — | — | 5 | 5 | 5 | 5 | 5 | 5 | 5 | 5 | 5 |
| R5 | Ref. 1 | 10 | 1 | 10 | 5 | 5 | 5 | 5 | 5 | 5 | 5 | 5 | 5 |
| R6 | Ref. 2 | 10 | 1 | 10 | 5 | 5 | 5 | 5 | 5 | 5 | 5 | 5 | 5 |
| B22 | HV5 | 10 | 1 | 10 | 4 | 4 | 1 | 4 | 4 | 3 | 4 | 4 | 2 |
| B23 | HV8 | 10 | 1 | 10 | 4 | 3 | 1 | 4 | 5 | 3 | 4 | 5 | 3 |
| B24 | SA | 10 | 1 | 10 | 3 | 1 | 1 | 3 | 2 | 2 | 1 | 2 | 1 |
| B25 | SA | 10 | 2 | 10 | 2 | 1 | 1 | 2 | 1 | 2 | 1 | 1 | 1 |

*= Number of applications of the adhesion promoter composition.

Table 5 lists the adhesion values for heat-cured silicone coatings based on a different silicone composition than in Tables 3 and 4. Comparing with the analogous silicone coatings in Table 3 shows definite differences. However, here it is also shown that adhesion of the silicone coatings according to the invention is generally considerably improved compared to the reference coatings, and that using adhesion promoter compositions containing organotitanium compounds results in considerably improved adhesion, in particular after poultice storage.

Tables 6, 7, and 8 show that it is important to properly place the step of application of the adhesion promoter composition within the production process.

TABLE 6
Adhesion of adhesive to polycarbonate coated with heat-cured
silicone coatings (PHC587 as the silicone composition).

| PHC587 | Adhesion | Tₓ | | T_{y} | SF221 | | | STP | | | STUF | | |
|---|---|---|---|---|---|---|---|---|---|---|---|---|---|
| Coating | promoter | [min] | #* | [min] | EC | WS | PS | EC | WS | PS | EC | WS | PS |
| R1 | — | — | — | — | 5 | 5 | 5 | 5 | 5 | 5 | 5 | 5 | 5 |
| R2 | Ref. 1 | 10 | 1 | 10 | 5 | 5 | 5 | 5 | 5 | 5 | 5 | 5 | 5 |
| R3 | Ref. 2 | 10 | 1 | 10 | 5 | 5 | 5 | 5 | 5 | 5 | 5 | 5 | 5 |
| B9 | SA | 10 | 1 | 10 | 1 | 2 | 3 | 3 | 2 | 5B | 3 | 2 | 5B |
| R7 | SA | 0 | 1 | 20 | 5 | 5 | 5 | 5 | 5 | 5 | 5 | 5 | 5 |
| R8 | SA | — | 1 | 10** | 5 | 5 | 5 | 5 | 5 | 5 | 5 | 5 | 5 |

*= Number of applications of the adhesion promoter composition.
**= the air-drying time of 10 minutes refers to application of the adhesion promoter composition to the baked coating.

When a heat-cured silicone coating without addition of an adhesion promoter composition, i.e., a hardcoat silicone coating corresponding to the prior art was prepared and the adhesion promoter composition as in Example R8 and R11 was only applied after baking and cooling using a lint-free cloth soaked with the adhesion promoter composition, in contrast to the silicone coatings B9 and B22 according to the invention, no improvement at all in the adhesion was found and the poor adhesion was comparable to that of the reference coatings R1, R2, R3, R4, R5, and R6.

Likewise, in R7, application of the adhesion promoter composition without partial air-drying of the silicone composition, i.e., wet-on-wet application (Tₓ=0) improved the adhesion of the adhesive only a little.

TABLE 7
Adhesion of adhesive to polycarbonate coated with heat-cured
silicone coatings (AS4700 as the silicone composition). Influence of
amount and partial air-drying time.

| AS4700 | Adhesion | Tₓ | | T_{y} | SF221 | | | STP | | | STUF | | |
|---|---|---|---|---|---|---|---|---|---|---|---|---|---|
| Coating | promoter | [min] | #* | [min] | EC | WS | PS | RT | EC | PS | EC | WS | PS |
| R4 | — | — | — | — | 5 | 5 | 5 | 5 | 5 | 5 | 5 | 5 | 5 |
| R5 | Ref. 1 | 10 | 1 | 10 | 5 | 5 | 5 | 5 | 5 | 5 | 5 | 5 | 5 |
| R6 | Ref. 2 | 10 | 1 | 10 | 5 | 5 | 5 | 5 | 5 | 5 | 5 | 5 | 5 |
| B22 | HV5 | 10 | 1 | 10 | 4 | 4 | 1 | 4 | 4 | 3 | 4 | 4 | 2 |
| R9 | HV5 | — | 1 | 20 | 5 | 5 | 5 | 5 | 5 | 5 | 5 | 5 | 5 |
| R10 | HV5 | — | 1 | 10** | 5 | 5 | 5 | 5 | 5 | 5 | 5 | 5 | 5 |

*= Number of applications of the adhesion promoter composition.
**= the air-drying time of 10 minutes refers to application of the adhesion promoter composition to the baked coating.

TABLE 8
Addition of adhesion promoter substances to silicone compositions.

| | | Adhesion | |
|---|---|---|---|
| Experiment | Silicone composition | promoter substance | Observation |
| R11 | PHC5B7 | (BuO)₄Ti | precipitation |
| | 100 g | 1 g | |
| R12 | PHC587 | (BuO)₄Ti/A1170 | precipitation |
| | 100 g | 0.5 g/0.5 g | |
| R13 | PHC5B7 | A1170 | stable |
| | 100 g | 1 g | |
| R14 | AS4700 | (BuO)₄Ti | precipitation |
| | 100 g | 1 g | |
| R15 | AS4700 | (BuO)₄Ti/A1170 | precipitation |
| | 100 g | 0.5 g/0.5 g | |
| R16 | AS4700 | A1170 | stable |
| | 100 g | 1 g | |

For Examples R11 to R16 in Table 8, the adhesion promoter substances were added to the respective silicone composition in a dose of 1 g of adhesion promoter substance (=Organosilicon compound+organotitanium compound) per 100 g of silicone composition.

But here it was proven that in all the experiments containing organotitanium compounds, i.e., R11, R12, R14, and R15, precipitation occurred immediately after addition. Because of this heterogeneity, such compositions could not used as coating material. But the compositions R13 and R16 remained homogeneous. However, here it was shown that no improvement at all in adhesion was achieved for the heat-cured silicone coatings not according to the invention, for which these mixtures of adhesion promoter substance/silicone composition as described were applied to the thermoplastic (R13) or to the previously primered thermoplastic (R16), and as described were baked after 20 minutes of air-drying and allowed to cool (Table 9).

TABLE 9
Adhesion to heat-cured silicone coatings based on an adhesion
promoter substance/silicone composition mixture.

| | SF221 | | | STP | | | STUF | | |
|---|---|---|---|---|---|---|---|---|---|
| | EC | WS | PS | RT | EC | PS | EC | WS | PS |
| R13 | 5 | 5 | 5 | 5 | 5 | 5 | 5 | 5 | 5 |
| R16 | 5 | 5 | 5 | 5 | 5 | 5 | 5 | 5 | 5 |

### Bonding of Silicone Coatings

A bead of Sikaflex®-221 was applied to the silicone coatings given in Table 10, without pre-application of an adhesive primer. Then a likewise unprimered or primered plate made of the respective material given in Table 1 for the joining part was pressed onto the adhesive bead, resulting in an adhesive layer thickness of 3 mm. This composite was stored for 7 days at 23° C., 50% relative air humidity. None of the composites could be adhesively separated using a wedge driven in by a hammer.

TABLE 10
Bonding of hardcoat-polycarbonates and various joining parts
using Sikaflex ®-221.

| Coating | Joining part | | | | |
|---|---|---|---|---|---|
| B5 | Float glass*\hat{ } | Steel sheet with auto | AlMgSi1*^{†} | Stainless steel 1.4301*^{†} | B5^{‡} |
| | | lacquer^{x} | | | |
| B8 | Float glass*\hat{ } | Steel sheet with auto | AlMgSi1*^{†} | Stainless steel 1.4301*^{†} | B8^{‡} |
| | | lacquer^{x} | | | |
| B21 | Float glass*\hat{ } | Steel sheet with auto | AlMgSi1*^{†} | Stainless steel 1.4301*^{†} | B21^{‡} |
| | | lacquer^{x} | | | |
| B23 | Float glass*\hat{ } | Steel sheet with auto | AlMgSi1*^{†} | Stainless steel 1.4301*^{†} | B23^{‡} |
| | | lacquer^{x} | | | |
| B24 | Float glass*\hat{ } | Steel sheet with auto | AlMgSi1*^{†} | Stainless steel 1.4301*^{†} | B24^{‡} |
| | | lacquer^{x} | | | |
| B26 | Float glass*\hat{ } | Steel sheet with auto | AlMgSi1*^{†} | Stainless steel 1.4301*^{†} | B26^{‡} |
| | | lacquer^{x} | | | |

*From Rocholl, Germany
\hat{ }Pretreatment: Sika ® Aktivator (available from Sika Schweiz AG)
^{x}Pretreatment: Sika ® Primer-206 G + P (available from Sika Schweiz AG)
^{†}Pretreatment: sanded and wiped clean with isopropanol-soaked cloth and with Sika ® Primer-204 N (available from Sika Schweiz AG).
^{‡}unprimered

1. Process for preparation of a heat-cured silicone coating on a thermoplastic, characterized in that it includes the following steps:
application of a silicone composition to the surface of a thermoplastic or to the surface of a thermoplastic treated with a plastic primer at least one partial air-drying of the silicone composition to form a silicone film
application of an adhesion promoter composition to the silicone film
baking at a temperature between 80° C. and 200° C.

2. Process as in claim 1, characterized in that the silicone composition includes an aqueous dispersion of a colloidal silicic acid in a mixture of water and an organic solvent and at least one trialkoxysilane RSi(OR¢)3 or its silanol RSi(OR¢)3-n(OH)n or partial condensates thereof, and wherein
R represents an alkyl substituent with 1-3 carbon atoms or an aryl substituent with 6 to 13 carbon atoms;
R¢ represents an alkyl substituent with 1-3 carbon atoms and n=1, 2, or 3.

3. Process as in claim 2, characterized in that R=methyl and R¢=methyl.

4. Process as in claim 1, characterized in that the silicone composition has a solids content from 10 to 30 wt. %, in particular 15 to 25 wt. %.

5. Process as in claim 1, characterized in that the adhesion promoter composition includes at least one organosilicon compound which has at least one alkoxy group bonded to a silicon atom as well as at least one organic substituent bonded to a silicon atom through a carbon-silicon bond.

6. Process as in claim 1, characterized in that the adhesion promoter composition includes at least one organotitanium compound which has at least one substituent bonded to the titanium atom through an oxygen-titanium bond.

7. Process as in claim 1, characterized in that the adhesion promoter composition includes at least one organosilicon compound which has at least one alkoxy group bonded to a silicon atom as well as at least one organic substituent bonded to a silicon atom through a carbon-silicon bond,
as well as
at least one organotitanium compound which has at least one substituent bonded to the titanium atom through an oxygen-titanium bond.

8. Process as in claim 6, characterized in that the at least one substituent bonded to the titanium atom through an oxygen-titanium bond is selected from the group including an alkoxy group, sulfonate group, carboxylate group, dialkyl phosphate group, dialkyl pyrophosphate group, and acetylacetonate group.

9. Process as in claim 7, characterized in that the at least one substituent bonded to the titanium atom through an oxygen-titanium bond is selected from the group including an alkoxy group, sulfonate group, carboxylate group, dialkyl phosphate group, dialkyl pyrophosphate group, and acetylacetonate group.

10. Process as in claim 5, characterized in that the organosilicon compound has formula (I) or (II) or (III):
wherein
R1 represents a linear or branched, optionally cyclic alkylene group with 1 to 20 C atoms, optionally with aromatic moieties and optionally with one or more heteroatoms, in particular nitrogen atoms; and
R2 stands for an alkyl group with 1 to 5 C atoms, in particular a methyl or ethyl group; and
R3 stands for an alkyl group with 1 to 8 C atoms, in particular a methyl group; and
X stands for an H or a functional group selected from the group including oxirane, OH, (meth)acryloxy, amine, SH, acylthio and vinyl, preferably amine; and
X1 stands for a functional group selected from the group including NH, S, S2, and S4; and
X2 stands for a functional group selected from the group including N and isocyanurate; and
a stands for one of the values 0, 1, or 2, preferably 0.

11. Process as in claim 10, characterized in that the substituent R1 is a methylene, propylene, methylpropylene, butylene, or dimethylbutylene group, preferably a propylene group.

12. Process as in claim 11, characterized in that X═NH2 or NH2-CH2-CH2-NH and X1=NH and X2=N.

13. Process as in claim 5, characterized in that the adhesion promoter composition includes at least one solvent with a boiling point at 760 torr between 25° C. and 140° C., in particular between 50° C. and 120° C., preferably between 65° C. and 99° C.

14. Process as in claim 13, characterized in that the adhesion promoter composition includes a mixture of at least one hydrocarbon and at least one polar solvent which has at least one heteroatom in its structural formula.

15. Process as in claim 13, characterized in that the at least one solvent is an alcohol or an aliphatic hydrocarbon or a cycloaliphatic hydrocarbon, in particular ethanol, isopropanol, hexane, cyclohexane, heptane, or octane, preferably ethanol or heptane.

16. Process as in claim 5, characterized in that the adhesion promoter composition has an organosilicon compound and/or organotitanium compound content of 1 to 20 wt. %, in particular between 2 and 10 wt. %.

17. Process as in claim 1, characterized in that the adhesion promoter composition is applied to the silicone film in an amount between 10 and 200 g/m2, in particular between 30 and 100 g/m2.

18. Process as in claim 5, characterized in that 0.02 to 40 g/m2, in particular 0.1 to 20 g/m2, preferably 0.5 to 10 g/m2 of the organosilicon compound and/or organotitanium compound is applied to the silicone film.

19. Process as in claim 1, characterized in that the thermoplastic is a polycarbonate, in particular an aromatic polycarbonate.

20. Process as in claim 1, characterized in that the partial air-drying time for the silicone composition is between 5 minutes and 60 minutes, in particular between 5 and 30 minutes, preferably between 5 and 25 minutes.

21. Process as in claim 1, characterized in that the baking is carried out at a temperature between 100° C. and 140° C., in particular for a baking time from 30 minutes to 90 minutes.

22. Heat-cured silicone coating, characterized in that it is prepared according to a process as in claim 1.

23. Process for bonding heat-cured silicone coatings as in claim 22, characterized in that an adhesive is brought into contact with the heat-treated silicone coating, without applying an adhesive primer beforehand to the heat-cured silicone coating.

24. Process for bonding as in claim 23, characterized in that the heat-cured silicone coating is bonded to another joining part using an adhesive.

25. Process for bonding as in claim 24, characterized in that the other joining part is a plastic.

26. Process for bonding as in claim 24, characterized in that the other joining part is a metal, in particular a lacquered metal.

27. Process for bonding as in claim 24, characterized in that the other joining part is glass or glass ceramic, in particular a panel.

28. Process for bonding as in claim 24, characterized in that the other joining part is pretreated with a primer before bonding.

29. Process for bonding as in claim 23, characterized in that the adhesive is a one-component moisture-curing polyurethane adhesive containing isocyanate-terminated polyurethane prepolymer.

30. Composite which is prepared by means of a process for bonding as in claim 23 and wherein the adhesive is cured.

31. Composite as in claim 30, characterized in that the composite is a vehicle, in particular an automobile, or a portion thereof.

32. Composite as in claim 30, characterized in that the composite is a display for representation of information.

33. Use of an adhesion promoter composition as described in claim 5 to improve adhesion of adhesives for silicone coatings.
